(19) United States
(12) Patent Application Publication
(10) Pub. No.: US 2004/0027372 A1
(43) Pub. Date: Feb. 12, 2004

(54) Method and electronic apparatus capable of synchronously playing the related voice and words

(76) Inventors: Cheng-Shing Lai, Taipei (TW); Xuwei Tu, NanJing (CN)

Correspondence Address: RABIN & Berdo, PC, 1101 14TH STREET, NW, SUITE 500, WASHINGTON, DC, 20005, US

(21) Appl. No.: 10/216,569

(22) Filed: Aug. 12, 2002

(51) Int. Cl. G09G 5/00

(52) U.S. Cl. 345/723; 715/500.1

(57) ABSTRACT

An electronic apparatus and a method capable of playing the related voice and the words in synchronous manner are disclosed. The electronic apparatus includes a storage unit, a control unit, a playing unit, and a displaying unit. The storage unit is used to store the digital voice file and document information file that are related to each other. When the voice data of the digital voice file is selected for playing, the control unit then fetches a corresponding information data of the document information file, according to the current playing period with respect to the voice data of the digital voice file, and exports the information data to the displaying unit for synchronous displaying. When a information data with respect to one playing period is selected for displaying, the control unit then drives the playing unit, according to this playing period, to play the voice data of the digital voice file with respect to the playing period in a synchronous manner.

### BACKGROUND OF THE INVENTION

1. Field of the Invention

This invention relates to an electronic apparatus and a method capable of playing the voice, and more particularly, the invention relates to an electronic apparatus and a method capable of playing the related voice and the text in a synchronous manner.

2. Description of Related Art

For the current modern world with scientific technology in great development, the information is available in the multiple formats, and under the current trend of internationalization, it is advantageous for the modern person to learn various kinds of languages. During the process of learning a new language, the voice playing apparatus, such a Walkman player or a language learning machine, can be a beneficial and important tool. For example, the portable Walkman allows the user to listen to the language learning tape conveniently at any time and any place, so as to train the user's ability of listening comprehension. Furthermore, the user can use the language learning machine to repeatedly listen to the language learning tape as desired, so as to personally improve the degree of familiarity of the language.

However, the Walkman player has the function to play the language tape, but not the function to play the voice and synchronously display the text. This disadvantage means that the user can only listen to the voice but not see the related words, lessening the opportunity for the user to learn the language. Further still, the language learning machine also can only provide the function to repeatedly read the language tape but usually can not display the related sentence words or allow the user to select the words in advance, and repeatedly play the voice with respect to the words being selected. This is very inconvenient.

### SUMMARY OF THE INVENTION

It is therefore an objective of the present invention to provide an electronic apparatus and a method capable of playing the related voice and text in a synchronous manner. The present invention can make a relation for the digital voice file and the document information file by an automatic way or a manual way, in order to achieve the effect of playing the digital voice file and the document information file in a synchronous manner. This would be very helpful to the user in learning the language.

In accordance with the foregoing objective, the present invention provides an electronic apparatus capable of playing the related voice and words in a synchronous manner. The electronic apparatus includes a storage unit, a control unit, a playing unit, and a displaying unit, in which the storage unit is used to store the digital voice file and the related document information file. The document information file includes the record of a corresponding voice file name with respect to a voice file name of the digital voice file, the record of a number of information data with respect to the voice data of the digital voice file, and the record of a number of playing periods with respect to the information data. The control unit is coupled to the storage unit, and is used to compare the voice file name and the corresponding voice file name, so as to relate the digital voice file to the document information file. The playing unit is coupled to the control unit, and is used to play the voice data of the digital voice file. The displaying unit is coupled to the control unit, and is used to display the information data. After the voice data of the digital voice file is selected for playing, the control unit fetches a first information data, according to the current playing period with respect to the voice data of the digital voice file, and then exports the first information data to the displaying unit for synchronous displaying. Or, when a second information data with respect to one playing period is selected for displaying, the control unit then drives the playing unit, according to this playing period, to play the voice data of the digital voice file with respect to the playing period in a synchronous manner.

In accordance with the foregoing and another objectives of the present invention, the invention provides a method and an apparatus capable of playing the related voice and the text in a synchronous manner. The first step of the method is to select a digital voice file, in which the digital voice file has a voice file name and a voice file size. Then, an information file list is opened. Next, according to a document information file of the information file list, a corresponding voice file name and a parameter of the file length with respect to the document information file are fetched sequentially, and compared respectively with the voice file name and the voice file size of the digital voice file. Afterward, in the following step, the digital voice file and the document information file with respect to the digital voice file are related. Then, the voice data of the digital voice file is selected for playing, or a first information data with respect to the playing period is selected for displaying. In the next step, according to the current playing period with respect to the voice data of the digital voice file, a second information data is fetched and synchronously displayed, or according to the playing period, the voice data of the digital voice file with respect to the playing period is played.

In accordance with the foregoing and other objectives of the present invention, the invention provides a method capable of playing the related voice and the words in a synchronous manner. The first step of the method includes selecting a digital voice file in which the digital voice file has a voice file name and a voice file size. Then, a document information file with respect to the digital voice file is selected, and a relation is made for the digital voice file and the document information file. Next, a voice data of the digital voice file is selected for playing, or a first information data with respect to the playing period is selected for displaying. Afterward, according to the current playing period with respect to the voice data of the digital voice file, a second information data is fetched and synchronously displayed, or according to the playing period, the voice data of the digital voice file with respect to the playing period is played.

### BRIEF DESCRIPTION OF DRAWINGS

The invention can be more fully understood by reading the following detailed description of the preferred embodiments, with reference made to the accompanying drawings, wherein:

FIG. 1 is a system block diagram, schematically illustrating an electronic apparatus capable of playing the related voice and words in a synchronous manner, according to a preferred embodiment of the present invention;

FIG. 2 is a structural diagram, schematically illustrating the relation between the digital voice file and the corresponding document information file, according to a preferred embodiment of the present invention,

FIG. 3 is a flow diagram, schematically illustrating the process for making the relation between the voice and the words by an automatic manner, according to a preferred embodiment of the present invention;

FIG. 4 is a flow diagram, schematically illustrating the process for making the relation between the voice and the words by a manual manner, according to a preferred embodiment of the present invention;

FIG. 5 is a flow diagram, schematically illustrating the process for the option of selecting the playing voice in advance and synchronously displaying the corresponding words, according to a preferred embodiment of the present invention;

FIG. 6 is a flow diagram, schematically illustrating the process for the option of selecting the displaying words in advance and synchronously playing the corresponding voice, according to a preferred embodiment of the present invention;

### DETAILED DESCRIPTION OF PREFERRED EMBODIMENTS

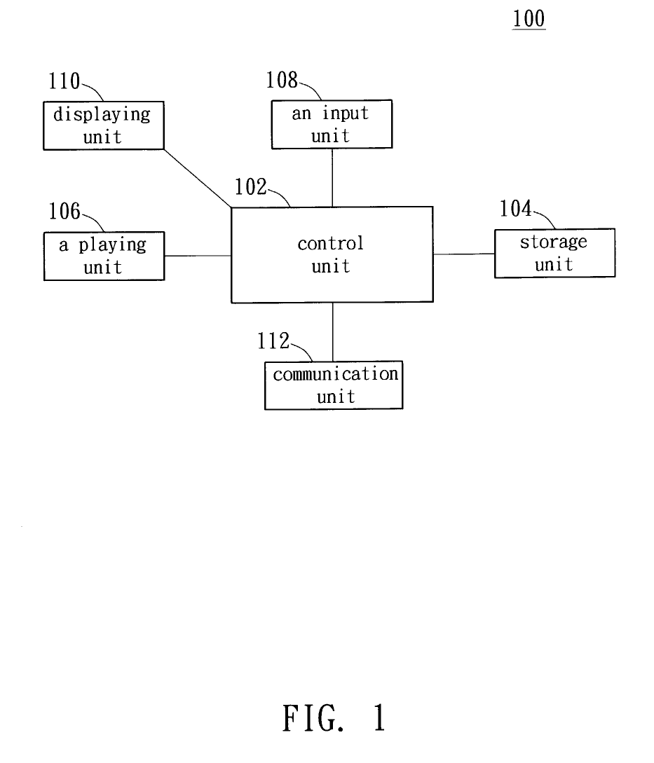

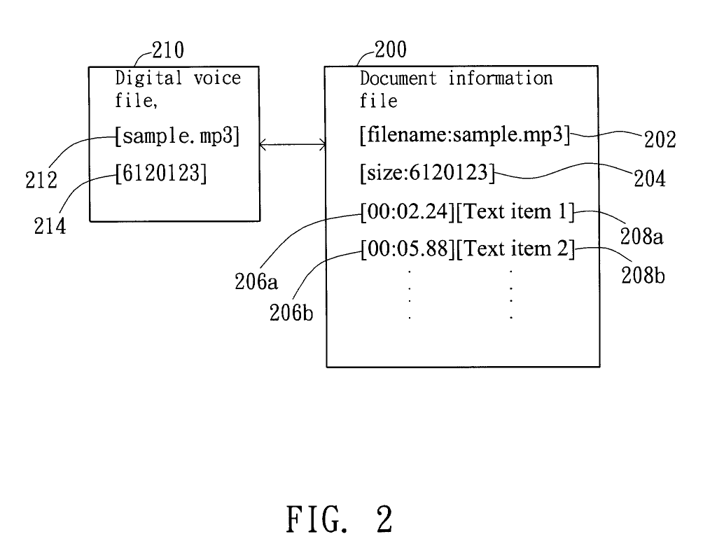

Referring to FIG. 1, it is a system block diagram, schematically illustrating an electronic apparatus capable of playing the related voice and text in a synchronous manner, according to a preferred embodiment of the present invention. As shown in FIG. 1, an electronic device 100 includes a control unit 102, a storage unit 104, a playing unit 106, an input unit 108, a displaying unit 110, and a communication unit 112. The storage unit 104 is coupled to the control unit 102, and is used to store at least one digital voice file and a document information file related to the digital voice file. The corresponding relation between the digital voice file and the document information file is shown in FIG. 2.

As shown in FIG. 2, the digital voice file 210 includes a voice file name 212 and a voice file size 214. The document information file 200 includes a corresponding voice file name 202, a parameter of file length 204, a number of information data, such as the information data 208a and 208b, and a number of playing periods, such as the playing periods 206a and 206b, corresponding to each one of the information data. The information data 208a and 208b are the records of the voice data and the corresponding text, such as a word phase, a sentence, a paragraph, an article, and so on. The playing periods 206a and 206b represent the playing periods with respect to the information data 208a and 208b of the digital voice file 210 being playing.

The corresponding voice file name 202 in the document information file 200, such as the [filename:sample.mp3] as shown in FIG. 2, is with respect to the voice file name 212 of the digital voice file 210. Also, the parameter of the file length 204 for the document information file 200, such as [size: 6120123] as shown in FIG. 2, is with respect to the voice file size 214 of the digital voice file 210. According to the foregoing information of the corresponding voice file name 202 and the parameter of file length 204, a corresponding relation between the document information file 200 and the digital voice file 210 can be set up. In addition, the contents of the information data 208a and 208b in the document information file 200 are with respect to the voice data in the digital voice file 210, so as to allow for the user to learn the language with the voice and the words in reference to each other.

As shown in FIG. 1, the playing unit 106 is coupled to the control unit 102, and is used to play the voice data of the digital voice file 210. The input unit 108 is coupled to the control unit 102, and is used to receive the instructions input by the user. The displaying unit 110 is coupled to the control unit 102, and is used to display the information data 208a and 208b of the document information file 200. The communication unit 112 is coupled to the control unit 102, and is used to connect with the Internet for downloading the digital voice file 210 and the document information file 200, in which a relation between the two can be set up.

Generally speaking, even though the digital voice file and the document information file in the market are generated in relation, when they are in play, the relation between them is still not set yet. For this reason, in order to achieve the objective of synchronously playing the digital voice file and the document information file, the control unit 102 compares the voice file name of the digital voice file with the corresponding voice file name of the document information file, in order to relate the digital voice file to the document information file. Furthermore, the control unit 102 can compare the voice file size of the digital voice file with the parameter of file length of the document information file, so as to improve the precision of the relation between the digital voice file and the document information file.

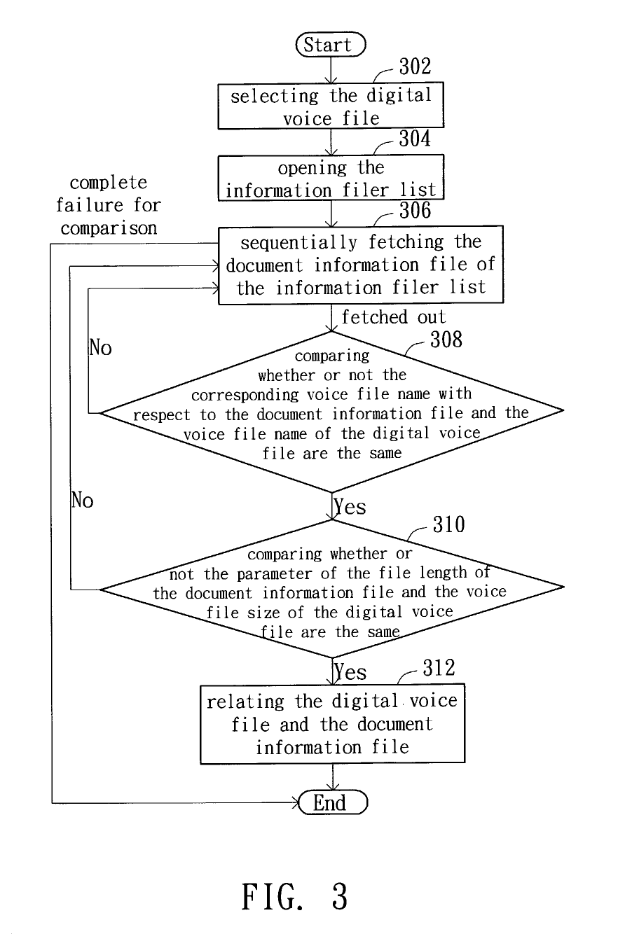

Referring to FIG. 3, it is a flow diagram, schematically illustrating the process for making the relation between the voice and the words by an automatic manner, according to a preferred embodiment of the present invention. Referring the FIG. 1, FIG. 2, and FIG. 3 at the same time, first in the step 302, the present invention provides for the user to select a digital voice file. For example, the user can view the voice file list of the digital voice file on the displaying unit 110 and then the input unit 108 allows the user to select a digital voice file, which is to be related in action, from the voice file list. After that, entering the step 304, one information file list is opened, so as to list all of the candidates of the document information files. These document information files would be matched one by one with the digital voice file selected in the step 302. The user can open the information file list via the input unit 108.

Then in the step 306, the document information file is sequentially fetched from the information file list, so that the comparison procedure is performed. After the document information file is fetched, the method continues to the step 308, in which the control unit 102 does the comparison of the corresponding voice file name of the document information file with the voice file name of the digital voice file to determine whether or not they are the same. If they are the same, then the method enters the step 310. If they are not, then the method goes back to the step 306, and sequentially fetches the next document information file for performing the comparison. For example, if the voice file name of the selected digital voice file is [okwap.mp3] and the corresponding voice file name of the document information file being selected is [filename: okwap.mp3], the control unit 102 via the comparison procedure can know that the corresponding voice file name of the document information file and the voice file name of the digital voice file are the same. Then, the method goes to the step 310.

Next, in the step 310, the control unit 102 compares the parameter of file length of the document information file with the voice file size of the digital voice file to see whether they are the same. If they are, then the method goes to the step 312. If they are not, then the method goes back to the step 306, and sequentially fetches the next document information file for performing the comparison again. For example, if the voice file size of the selected digital voice file is [910314] and the parameter of file length of the document information file being selected is [size: 910314], the control unit 102 via the comparison process can know that the parameter of file length of the document information file and the voice file size of the digital voice file are the same. Then, the method goes to the step 312.

After the comparison, a relation of the digital voice file and the document information file is known and thus determined in the step 312. And then, the method goes to the end.

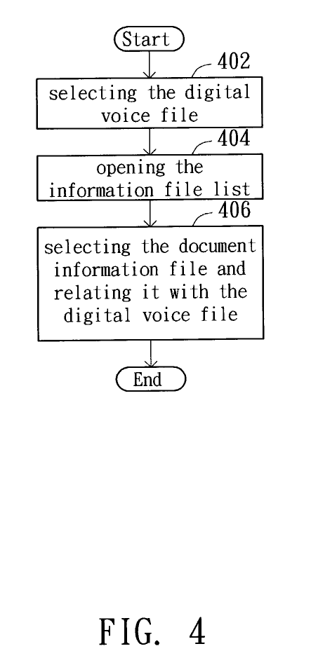

Referring to FIG. 4, it is a flow diagram, schematically illustrating the process for making the relation between the voice and the text by a manual manner, according to a preferred embodiment of the present invention. As shown in FIG. 4, first, in the step 402, the user selects a digital voice file. For example, the user can view the voice file list of the digital voice file on the displaying unit 110, and the input unit 108 allows the user to select a digital voice file, which is to be related in action, from the voice file list. After that, in the step 304, one information file list is opened, in order to list all of the candidates of the document information files. The user can use the playing unit 106 to play the selected digital voice file and has a pre-listening for making the selection.

Then, the method enters the step 404, in which the information file list is opened and used to list all of the available document information files and to allow the user to select the desired document information file. The user can easily open the information file list via the input unit 108, and all of the document information files can be displayed at the displaying unit 110.

Next, the method enters the step 406. The user can select one document information file from the information file list and have a preview of the information data of the document information file. After the user has confirmed the selection, a relation can be set up with respect to the digital voice file. The method then goes to the end.

When a relation between the digital voice file and the document information file is set up, the user then can play the voice data of the digital voice file and display the information data of the document information file in a synchronous manner.

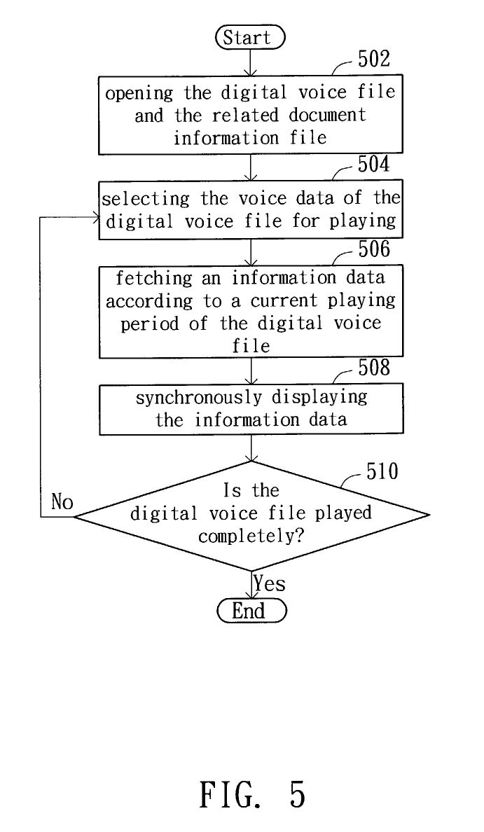

Referring to FIG. 5, it is a flow diagram, schematically illustrating the process for the option of selecting the playing voice in advance and synchronously displaying the corresponding words, according to a preferred embodiment of the present invention. As shown in FIG. 5, at first, in the step 502, the digital voice file and the related document information file can be opened. For example, the user can view the voice file list of the digital voice file on the displaying unit 110. The user then can select the one of digital voice files, which is to be opened, from the voice file list via the input unit 108. Each digital voice files has a corresponding document information file, respectively. For the process of determining the relation has been described above, with reference to FIG. 3 and FIG. 4. Thus, descriptions of this process are not repeated further.

After the relation is determined, the method goes to the step 504, in which the voice data with respect to the digital voice file is played, wherein the user can input the necessary instruction for playing the voice via the input unit 108 and accordingly generate a signal for playing the voice. The control unit 102 then receives the signal for playing the voice, and controls the displaying unit 106 to play the voice data accordingly with respect to the digital voice file stored in the storage unit 104. Next, the method goes to the step 506. When the control unit 102 controls the displaying unit 106 to accordingly play the voice data plays, the control unit 102 will fetch an information data, according to the current playing period with respect to the voice data, and input it to the displaying unit 110. Then, the method goes to the step 508, in which the control unit 102 will control the displaying unit 110 to display the information data in a synchronous manner. Afterward, the method goes to the step 510, in which the control unit 102 will judge whether or not the voice data has played to completion. If it has, then the method goes to the end. If it has not, then the method goes back to the step 504, and continuously displays the voice data until the playing action is completed.

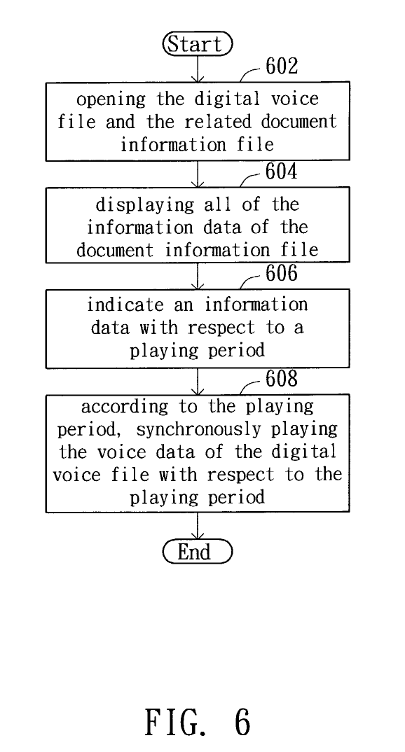

Referring to FIG. 6, it is a process flow diagram, schematically illustrating the process for the option of selecting the displaying words in advance and synchronously playing the corresponding voice, according to a preferred embodiment of the present invention. As shown in FIG. 6, in the step 602, the digital voice file and the related document information file first are opened. For example, the user can view the voice file list of the digital voice file on the displaying unit 110, and then select one digital voice file, which is to be opened, from the voice file list via the input unit 108.

Then, the method goes to the step 604, in which the displaying unit 110 displays all of the selected document information files, so as to allow the user to view the information data files with respect to the document information files. Then, the method goes to the following step 604, in which the user can indicate an information data with respect to a playing period.

Afterward, the method goes to the step 608, in which the control unit 102 drives the playing unit 106, according to the playing period, to play the voice data of the digital voice file with respect to the playing period. Then, the method goes to the end.

In summary of the present invention, the foregoing embodiments of the present invention have disclosed the electronic apparatus and the method capable of playing the related voice and text in a synchronous manner. The invention includes the following number of advantages:

1. The present invention can provide an option for the automatic manner or the manual manner of setting up the relation of the digital voice file and the document information file.

2. The present invention can allow the user to directly play the selected voice and display the related words synchronously. This is very helpful for the user to learn the language.

3. The present invention can allow the user to directly display the selected words and play the related voice at the same time. The user can select the words, the whole sentence or the whole article, and can play the corresponding voice in repetition.

4. The present invention can have the strong correlation between the words and the voice, and it can also allow for the function of sound mixing, so called, i.e. Carro OK.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An electronic apparatus being capable of playing the related voice and text in a synchronous manner, the electronic apparatus comprising:
a storage unit, used to store at least one digital voice file and a document information file related to the digital voice file and the document information file having a corresponding voice file name, which is with respect to a voice file name of the digital voice file, a plurality of information data with respect to voice data of the digital voice file, and a plurality of playing periods with respect to the information data;
a control unit, coupled to the storage unit, used to compare the voice file name with the corresponding voice file name, so that a relation of the digital voice file and the document information file can be set up;
a playing unit, coupled to the control unit, used to play the voice data of the digital voice file; and
a displaying unit, coupled to the control unit, used to display the information data;
wherein when the voice data of the digital voice file is selected for playing, the control unit then fetches a first information data, according to the current playing period with respect to the voice data of the digital voice file, and exports the first information data to the displaying unit to be synchronously displayed, or when a second information data with respect to one of the playing periods is selected for displaying, the control unit then drives the playing unit, according to the one of the playing periods, to synchronously play the voice data of the digital voice file with respect to the one of the playing periods.

2. The electronic device as recited in claim 1, further comprising:
a communication unit, coupled to the control unit, used to connect to the Internet to download the digital voice file and the document information file.

3. The electronic device as recited in claim 1, wherein the document information file further comprises a parameter of file length with respect to a voice file size of the digital voice file.

4. The electronic device as recited in claim 1, further comprising a method for automatically relating the voice and text and synchronously playing, the method comprising:
selecting one digital voice file, the digital voice file having a voice file name and a voice file size;
opening an information file list;
sequentially fetching a corresponding voice file name with respect to one information file of the information file list and a parameter of file length, wherein the corresponding voice file name and the parameter of file length are respectively compared with the voice file name and the voice file size, so as to determine a document information file with respect to the digital voice file;
relating the digital voice file and the document information file that is with respect to the digital voice file;
selecting voice data for playing the digital voice file, or selecting a third information data with respect to a playing period; and
fetching a fourth information data and synchronously displaying the fourth information data according to the current playing period of the voice data of the digital voice file, or synchronously playing the Voice data of the digital voice file with respect to the playing period, according to the playing period.

5. The electronic device as recited in claim 1, further comprising a method for manually relating the voice and text and synchronously playing, the method comprising:
selecting one digital voice file, the digital voice file having a voice file name and a voice file size;
selecting a document information file with respect to the digital voice file, and relating the digital voice file with the document information file;
selecting the voice data of the digital voice file for playing, or selecting a third information data with respect to a playing period for displaying; and
fetching a fourth information data and synchronously displaying the fourth information data according to the current playing period of the voice data of the digital voice file, or synchronously playing the voice data of the digital voice file with respect to the playing period, according to the playing period.

6. A method for automatically relating the voice and text and synchronously playing, the method comprising:
selecting one digital voice file, the digital voice file having a voice file name and a voice file size;
opening an information file list;
sequentially fetching a corresponding voice file name with respect to one information file of the information file list and a parameter of file length, wherein the corresponding voice file name and the parameter of file length are respectively compared with the voice file name and the voice file size, so as to determine a document information file with respect to the digital voice file;
relating the digital voice file and the document information file that is with respect to the digital voice file; selecting voice data for playing the digital voice file, or selecting a first information data with respect to a playing period; and
fetching a second information data and synchronously displaying the second information data according to the current playing period of the voice data of the digital voice file, or synchronously playing the voice data of the digital voice file with respect to the playing period, according to the playing period.

7. A method for manually relating the voice and text and synchronously playing, the method comprising:
selecting one digital voice file, the digital voice file having a voice file name and a voice file size;
selecting a document information file with respect to the digital voice file, and relating the digital voice file with the document information file;
selecting the voice data of the digital voice file for playing, or selecting a first information data with respect to a playing period for displaying; and
fetching a second information data and synchronously displaying the second information data according to the current playing period of the voice data of the digital voice file, or synchronously playing the voice data of the digital voice file with respect to the playing period, according to the playing period.

8. A method for automatically relating the voice and text, the method comprising:
selecting one digital voice file, the digital voice file having a voice file name and a voice file size;
opening an information file list;
sequentially fetching a corresponding voice file name with respect to one information file of the information file list and a parameter of file length, wherein the corresponding voice file name and the parameter of file length are respectively compared with the voice file name and the voice file size, so as to determine a document information file with respect to the digital voice file; and
relating the digital voice file and the document information file that is with respect to the digital voice file.

9. A method for manually relating the voice and text, the method comprising:
selecting one digital voice file, the digital voice file having a voice file name and a voice file size; and
selecting a document information file with respect to the digital voice file, and relating the digital voice file with the document information file.
